(19) United States
(12) Patent Application Publication
(10) Pub. No.: US 2026/0151784 A1
(43) Pub. Date: Jun. 4, 2026

(54) PRODUCT APPLICATOR AND METHOD OF APPLYING PRODUCT

(71) Applicant: HCL Technologies Limited, New Delhi (IN)

(72) Inventors: Karthikeyan Sabapathy, Bengaluru (IN); Bhoomika Jain, Bengaluru (IN); Achal P M Kailash, Bengaluru (IN); Nikhil Soman, Bengaluru (IN); Darshan Chavhan, Bengaluru (IN); Athira E, Bengaluru (IN); S Shankar, Bengaluru (IN)

(21) Appl. No.: 19/094,815

(22) Filed: Mar. 29, 2025

(30) Foreign Application Priority Data
Nov. 30, 2024 (IN) 202411094157

(51) Int. Cl. B05C 1/08; A45D 40/26

(52) U.S. Cl. CPC B05C 1/0813; A45D 40/261

(57) ABSTRACT

The present disclosure relates to a product applicator. The product applicator may include a casing with a first product compartment accommodating a first product cartridge, a second product compartment disposed adjacent to the first product compartment accommodating a second product cartridge, and a cap pivoted to the casing. The cap rotatably slides over the second product compartment to rotate the slider guide to facilitate a vertical motion of the first product cartridge from the first product compartment.

### TECHNICAL FIELD

This disclosure generally relates to product application, and more particularly to product applicator and method of applying products.

### BACKGROUND

Product applicators for cosmetic products, such as but not limited to lipstick, lip balm, and the like, exist in a variety of colors and packaging. Such packaging allows the accommodation of one or more single-type products, for example, lipstick packaging may accommodate one or more lipstick products of various colors, balm packaging may include a single lip balm product, and the like. Users prefer to have different products at a time, and hence the user has to carry multiple packaging to use a desired color and product.

Conventionally available product applicators have a detachable cap, and product body with a swiveling mechanism that elevates the product from the applicator for application. While applying these products, both hands are engaged so as not to misplace the cap. For example, one hand is used for holding the applicator, and the other hand may be used to hold the detachable cap of the applicator. Such design limits the usage of the user's hands.

Therefore, there is a need for product applicators that offer single-handed usage with the accommodation of one or more types of products.

### SUMMARY

In an embodiment, a product applicator is disclosed. The product applicator may include a casing and a cap. The casing may include a first product compartment to receive a first product cartridge and a second product compartment to receive a second product cartridge. The cap may be pivoted to the center of the casing. The cap may configured to rotatably slide over the second product compartment. The cap of the product applicator may further include a slider guide engaged to the first product cartridge. The cap rotatably slides over the second product compartment to rotate the slider guide, thereby facilitating a vertical motion of the first product cartridge from the first product compartment.

In an embodiment, a method for applying a product is disclosed. The method may include sliding rotatably a cap about a second product compartment of a casing to rotate a slider guide attached to the cap facilitating a vertical motion of a first product cartridge from a first product compartment. The first product compartment is formed in the casing and configured to receive the first product cartridge. The second product compartment may be disposed adjacent to the first product compartment. The second product compartment may be configured to receive a second product cartridge. The method for applying a product may further include the cap pivoted to a center of the casing and the slider guide engaged to the first product cartridge.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates a perspective view of a product applicator, in accordance with some embodiments of the present disclosure.

FIG. 1B illustrates an internal-perspective view of a product applicator, in accordance with some embodiments of the present disclosure.

FIG. 2 illustrates a perspective view of the product applicator in an application configuration, in accordance with some embodiments of the present disclosure.

FIG. 3 illustrates a schematic of a refilling mechanism of a first product, in accordance with some embodiments of the present disclosure.

FIG. 4 illustrates a schematic of a refilling mechanism of a second product, in accordance with some embodiments of the present disclosure.

FIG. 5 illustrates a process flow diagram of operating the product applicator, in accordance with some embodiments.

### DETAILED DESCRIPTION

The foregoing description has broadly outlined the features and technical advantages of the present disclosure in order that the detailed description of the disclosure that follows may be better understood. Additional features and advantages of the disclosure will be described herein after which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

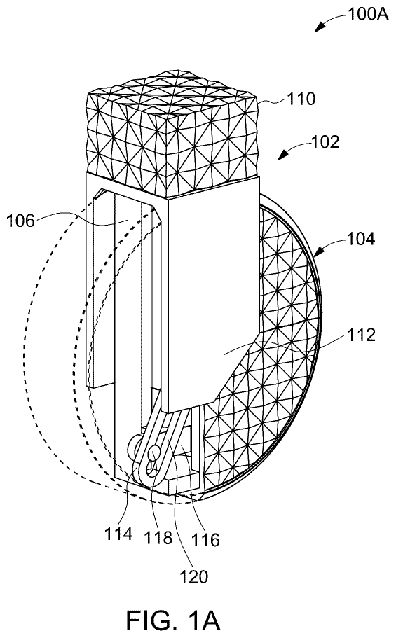

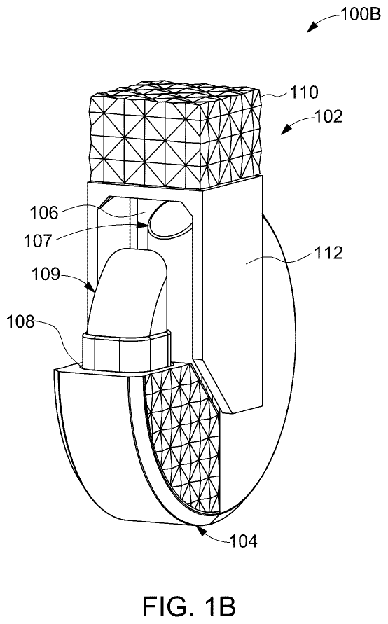

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1A-5.

Referring now to FIG. 1A, a perspective view 100A of a product applicator 102 is illustrated, and FIG. 1B, an internal-perspective view 100B of a product applicator 102 is illustrated, in accordance with some embodiments. The product applicator 102 may include a casing 104, a first product compartment 106, a second product compartment 108, a cap 110, a lever 112, a slider guide 114, a slider 116, and a pin 118.

The first product compartment 106 and the second product compartment 108 may be formed in the casing 104. The first product compartment 106 may be formed through the diameter of the casing 104, and the second product compartment 108 may be formed in any one section of the casing 104. The section at which the second product compartment 108 may be formed is positioned adjacent to the first product compartment 106. The first product compartment 106 and the second product compartment 108 may be configured to accommodate the first product cartridge 107 and the second product cartridge 109 respectively. The first product cartridge 107 may include a first product such as but not limited to cosmetic products such as lipsticks, and the second product cartridge 109 may include a second product such as but not limited to lip balms, and the like.

The cap 110 may be pivoted to a center of the casing 104 through the lever 112. Furthermore, the cap 110 may be configured to cover the first product compartment 106 such that the first product cartridge 107 is accommodated therein when the product applicator 102 is not used. When the product applicator 102 is used, the cap 110 may rotatably slide over the second product compartment 108 to elevate the first product cartridge 107 from the first product compartment 106.

The cap 110 may include the lever 112. As explained earlier, the cap 110 may be pivoted to a center of the casing 104. Particularly, the lever 112 may be pivoted to the center of the casing 104. In an embodiment, the lever 112 may be attached to the slider guide 114. Therefore, to rotate the cap 110, a manual force may be applied by the user to rotate the lever 112 about the center of the casing 104. It must be noted that the rotation of the lever 112 may also rotate the slider guide 114.

The first product cartridge 107 may be coupled to the slider 116. Further, the slider 116 may be disposed in the first product compartment 106. Further, from the slider 116, the pin 118 may extend horizontally and may be configured to slidingly engage the slider guide 114. Particularly, the slider guide 114 may include a groove 120 configured to engage with the pin 118. Further, the slider guide 114 may be configured to slide within the groove 120 when the cap 110 may be subjected to a rotary motion.

In particular, the assembly of the slider guide 114 with the pin 118 may be configured to form a scotch-yoke mechanism, i.e., a mechanism to convert rotary motion into a linear motion. With continued reference to FIG. 1A-1B, the rotation of the cap 110 may result in the rotation of the slider guide 114. The rotation of the slider guide 114 may further result in the sliding of the pin 118 within the groove 120. Hence, due to the sliding of the pin 118, the slider 116 may slide vertically within the first product compartment 106. Hence, the rotary motion of the cap 110 may result in the linear motion of the slider 116 within the first product compartment 106.

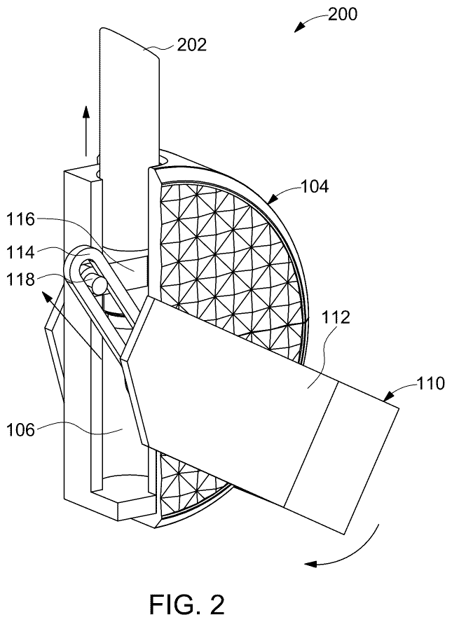

The rotation of the cap 110 may be implemented to configure the product applicator 102 in various configurations, such as a packed configuration and an application configuration. In the packed configuration, the first product cartridge 107, and the second product cartridge 109 may be accommodated within the first product compartment 106 and the second product compartment 108 respectively, as illustrated by FIGS. 1A-1B. In contrast, the application configuration may include the application of the first product cartridge 107, or the second product cartridge 109. For the application of the first product 202, the cap 110 may slidingly rotate over the second product compartment 108. The slider guide 114 rotates and facilitates a vertical motion of the pin 118 and dispenses the first product 202 from the first product compartment 106 of the casing 104 This is explained in detail, in conjunction with FIG. 2.

Referring now to FIG. 2, a perspective view 200 of the product applicator 102 in the application configuration is illustrated in accordance with an embodiment. The product applicator 102 may include the first product 202 in the first product compartment 106 of the casing 104.

As the cap 110 may be rotated in a clockwise direction (as shown by the indicia), the lever 112 may be rotated in unison. Accordingly, with the rotation of the lever 112, the slider guide 114 may also be rotated in unison. Therefore, with the rotation of the slider guide 114, the pin 118 may slide within the groove 120 of the slider guide 114 (as shown by the indicia). Accordingly, the sliding of the pin 118 may slide the slider 116 vertically upwards within the first product compartment 106. As may be appreciated, the first product cartridge being coupled to the slider 116 may also slide vertically upwards with the slider 116. Accordingly, the first product cartridge 107 may elevate from the first product compartment 106 for application.

To configure the product applicator 102 back to the packed configuration, the cap 110 may be rotated in a counterclockwise direction over the second product compartment 108. Accordingly, the lever 112 may be rotated in the counterclockwise direction which may consequently rotate the slider guide 114 in the counterclockwise direction. The pin 118 may slide within the groove 120 to coerce the slider 116 vertically downwards within the first product compartment 106. Hence, the first product cartridge 107 may be lowered within the first product compartment 106.

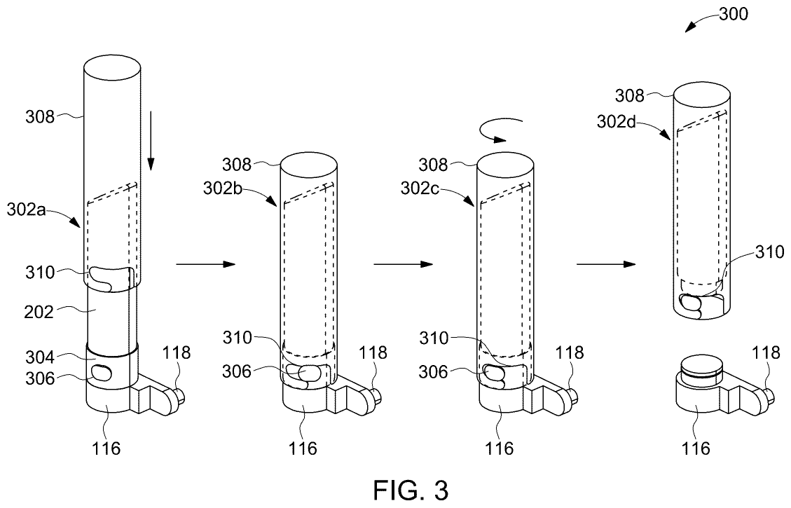

The first product compartment 106 and the second product compartment 108 as explained earlier, may be configured to accommodate the first product cartridge 107 and the second product cartridge 109 respectively. Moreover, the first product cartridge 107 or the second product cartridge 109 may be removed once completely used, or a desired shade or type of product is to be used by the user. After removal, the first product cartridge 107 and the second product cartridge 109 may be replaced by a refilled first product cartridge 107 and the second product cartridge 109 by a refilling mechanism. The refilling mechanism is explained in detail in conjunction with FIG. 3.

Referring now to FIG. 3, a schematic 300 of a refilling mechanism of the first product 202 is illustrated, in accordance with an embodiment of the present disclosure. In an embodiment, the first product cartridge 107 may include a first product 202 (refer to FIG. 2) coupled to a first base 304. The first base 304 may be coupled to the slider 116 via various attachment mechanisms known in the art, such as for example, magnetic attachments, screw-based attachments, and the like. Further, the first base 304 may include a base pin 306. Further, the refilling mechanism may utilize an enclosure 308 to facilitate removal of the first product cartridge 107 from the first product compartment 106, to expose the first product 202 to the user. The enclosure 308 may be formed as a hollow cylinder, and configured to accommodate the first product 202. The enclosure 308 may include a slot 310. The slot 310 may be configured to engage with the base pin 306 to adjoin the enclosure 308 with the first base 304. Particularly, the slot 310 may include a vertical portion and a horizontal portion. The base pin 306 may enter the vertical portion, and may further translate through the horizontal portion to lock the first base 304 with the enclosure 308. Further, the enclosure 308 may be pulled vertically upwards to disengage the first product cartridge 107 from the slider 116.

The refilling mechanism may be implemented as a series of steps to remove the first product cartridge 107 from the first product compartment 106, especially during the application configuration. At step 302a, the first product 202 may be enclosed by the enclosure 308. Particularly, the enclosure may be inserted within a clearance (not shown) formed within the first product 202 and the first product compartment 106. Further, at step 302b, after the enclosure 308 may completely accommodate the first product 202, the base pin 306 may enter a vertical portion of the slot 310. Further, at step 302c, the enclosure may be rotated such that a horizontal portion of the slot may accommodate the base pin 306. As such, the enclosure 308 may be locked to the first base 304. Further, at step 302d, the enclosure 308, along with the first product 202 and the first base 304 may be pulled and disconnected from the slider 116.

As such, in some embodiments, to refill the first product compartment 106, the steps 302a, 302b, 302c, and 302d may be reverse operated, i.e., the assembly of the enclosure 308 and the first base 304 may be inserted in the first product compartment 106 to couple the first base 304 with the slider 116. Further, the enclosure 308 may be rotated in a direction reverse to the direction of rotation illustrated by step 302c and may be detached from the first base 304. Hence, the enclosure 308 may be removed from the first product compartment 106 leaving the first product cartridge 107 coupled to the slider 116.

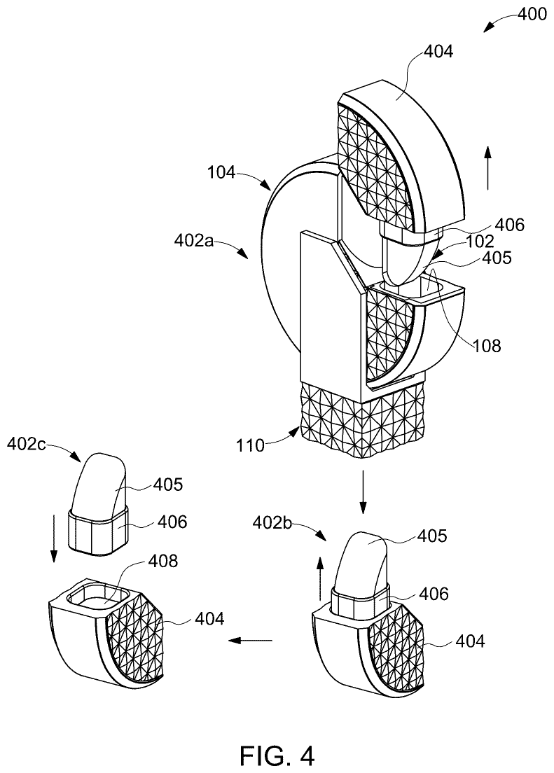

The refilling mechanism of the product applicator 102 may not be limited to the first product compartment 106. The refilling mechanism may also be implemented in the second product compartment 108 of the casing 104. This is explained in detail, in conjunction with FIG. 4.

FIG. 4 illustrates a schematic 400 of a refilling mechanism for the second product compartment 108. It must be noted that the refilling mechanism for the second product compartment 108 is implementable when the product applicator 102 is in the packed configuration. As explained earlier, the second product compartment 108 may be configured to accommodate the second product cartridge 109. The second product cartridge 109 may include a second product 405 coupled to a second base 406. The second base 406 may be coupled to a removable cap 404 via various attachment mechanisms known in the art, such as but not limited to, magnetic attachments, screw-based attachments, and the like. Particularly, the removable cap 404 may be formed as a section of the casing 104, over which the cap 110 may slide as the product applicator 102 may be maneuvered to the application configuration. The second base 406 may be fixated to a second product cartridge housing 408 formed in the removable cap 404.

The second base 406, along with the second product 405 may be removably accommodated within the second product compartment 108. Accordingly, the second product cartridge 109 may be removably accommodated within the second product compartment 108. Further, to replace, or refill the second product compartment 108, the refilling mechanism may be implemented which is explained hereon.

With continuous reference to FIG. 4, the refilling mechanism for the second product compartment 108 may be implemented as a plurality of steps 402a, 402b, and 402c. At step 402a, the removable cap 404 may be manually pulled (as indicated by an indicia) by the user from the casing 104 to disengage, or in other words, remove the second product 405 from the second product compartment 108. Further, at step 402b, the second base 406 may be disengaged from the removable cap 404. Due to such disengagement, the second product cartridge housing 408 may be exposed to accommodate a refilled second product cartridge 109, i.e., an assembly of a refilled second product 405 and the second base 406. Further, at step 402c, the refilled second product cartridge 109 may be accommodated within the second product cartridge housing 408 (as indicated by an indicia). Particularly, the second base 406 of the refilled second product cartridge 109 may be inserted within the second product cartridge housing 408. After insertion, the removable cap 404 may be accommodated back into the casing 104.

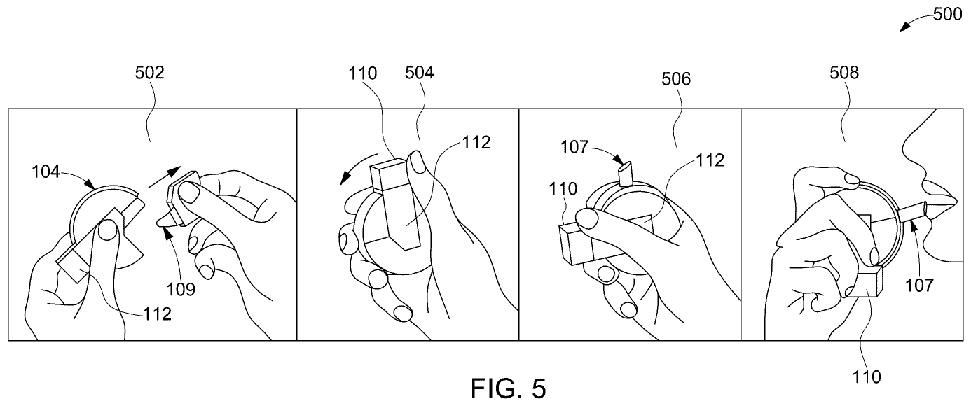

FIG. 5 illustrates a process flow diagram 500 of operating the product applicator 102, in accordance with an embodiment of the present disclosure. To use the product applicator 102, at step 502, the second product cartridge 109 may be disengaged from the second product compartment 108 during a packed configuration of the product applicator 102. The second product compartment 108, as explained earlier, may be disposed adjacent to the first product compartment 106.

At step 504, the cap 110 may be rotated about a center of the casing 104 over the second product compartment 108. As explained earlier, the cap 110 may include a lever 112 pivoted to the center of the casing 104 and attached to a slider guide 114, and the slider guide 114 may be engaged to the slider 116 via the pin 118. Therefore, with the rotation of the cap 110, the lever 112 may be rotated, which may also result in the rotation of the slider guide 114. The slider guide 114 may be engaged to the first product cartridge 107, which is already explained in conjunction with FIGS. 1A-4.

At step 506, the first product cartridge 107 may be elevated from the casing 104, or from the first product compartment 106 formed in the casing 104. As explained in step 504, with the rotation of the slider guide 114, the pin 118 may slide within the groove 120. Accordingly, the sliding of the pin 118 may also cause sliding of the slider 116 within the first product compartment 106. As a result, the first product cartridge 107 may elevate from the first product compartment 106. At step 508, after the first product cartridge 107 may be elevated, the product applicator 102 may be used by the user.

In conjunction with FIGS. 1A-5, the cap 110 may be rotated by a single hand of the user during the application configuration. Moreover, the removable cap 404 may be detached from the casing 104 by a single hand, or both hands of the user. Such configurations allow ease in handling the product applicator 102, especially with a single hand. Furthermore, with one or more types of products assembled in a single packaging, handling of multiple products at a time may be prevented.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a product applicator and method of applying product. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. It is intended that the disclosure and examples be considered as exemplary only, with a true scope and spirit of disclosed embodiments being indicated by the following claims.

What is claimed is:

1. A product applicator, comprising:
a casing comprising:
a first product compartment configured to receive a first product cartridge; and
a second product compartment disposed adjacent to the first product compartment; and
a cap pivoted to a center of the casing and configured to rotatably slide over the second product compartment, the cap comprising:
a slider guide engaged to the first product cartridge,
wherein the cap rotatably slides over the second product compartment to rotate the slider guide, thereby facilitating a vertical motion of the first product cartridge from the first product compartment.

2. The product applicator of claim 1, wherein the first product cartridge comprises:
a base; and
a first product coupled to the base.

3. The product applicator of claim 2, wherein the first product compartment comprises:
a slider removably coupled to the base via a first attachment mechanism; and
a pin extending horizontally from the slider and slidingly engaged to the slider guide.

4. The product applicator of claim 1, wherein the second product compartment is configured to receive a second product cartridge.

5. The product applicator of claim 4, wherein the second product cartridge comprises:
a removable cap; and
a second product coupled to the removable cap via a second attachment mechanism.

6. A method for applying a product, the method comprising:
sliding rotatably, a cap about a second product compartment of a casing to rotate a slider guide attached to the cap, thereby facilitating a vertical motion of a first product cartridge from a first product compartment, wherein:
the first product compartment is formed in the casing;
the second product compartment disposed adjacent to the first product compartment;
the cap is pivoted to a center of the casing; and
the slider guide is engaged to the first product cartridge.

7. The method of claim 6, wherein sliding rotatably, the cap further comprises:
the first product cartridge further comprising:
a base; and
a first product coupled to the base.

8. The method of claim 7, wherein sliding rotatably the cap further comprises:
the first product compartment further comprising:
a slider removably coupled to the base via a first attachment mechanism; and
a pin extending horizontally from the slider and slidingly engaged to the slider guide.

9. The method of claim 6, wherein sliding rotatably the cap further comprises:
the second product compartment (108) configured to receive a second product cartridge.

10. The method of claim 9, wherein sliding rotatably the cap further comprises:
the second product cartridge comprising:
a removable cap; and
a second product coupled to the removable cap via a second attachment mechanism.
